(19) United States
(12) Patent Application Publication
(10) Pub. No.: US 2014/0115096 A1
(43) Pub. Date: Apr. 24, 2014

(54) RECOMMENDING CONTENT BASED ON CONTENT ACCESS TRACKING

(71) Applicant: MICROSOFT CORPORATION, Redmond, WA (US)

(72) Inventors: Alexander Burba, Seattle, WA (US); Brandon Hunt, Redmond, WA (US); Frank R. Morrison, III, Seattle, WA (US); Mehmet Akkurt, Seattle, WA (US)

(73) Assignee: Microsoft Corporation, Redmond, WA (US)

(21) Appl. No.: 13/658,751

(22) Filed: Oct. 23, 2012

(51) Int. Cl. G06F 15/16

(52) U.S. Cl. 709/217

(57) ABSTRACT

Embodiments are disclosed that relate to generating digital content recommendations for a user based upon how the user accesses the assets of a digital content item. For example, one disclosed embodiment provides a method including receiving from a remote computing device content access information regarding an order in which content portions of a selected digital content item were accessed by the user, and, storing the content access information. The method further includes comparing the content access information for the user to content access information for other users that consumed the selected digital content item to determine other users with similar content access patterns, and sending digital content recommendations to the user based upon content consumption information for the other users.

### BACKGROUND

Different users may consume digital content in different ways. For example, in the example of a video game, some users may play the game slowly and methodically, trying to solve all challenges in a level before progressing to a next level, while others may skip optional challenges and instead progress to higher levels as soon as possible. Likewise, different users may choose to play a game as different characters, and/or otherwise customize a digital content experience differently.

### SUMMARY

Various embodiments are disclosed that relate to generating digital content recommendations for a user based upon how the user accesses the assets of a digital content item compared to other users of the digital content item. For example, one disclosed embodiment provides, on a computing device, a method including receiving from a remote computing device content access information regarding an order in which content portions of a selected digital content item were accessed by the user, and storing the content access information. The method further includes comparing the content access information for the user to content access information for a plurality of other users that consumed the selected digital content item to determine one or more other users with similar content access patterns. The method further includes sending one or more digital content recommendations for presentation to the user based upon digital content consumption information for the one or more other users with the similar content access patterns.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example embodiment of a digital content provision and consumption environment.

FIG. 2 shows a flow diagram depicting an embodiment of a method for providing digital content recommendations.

FIG. 3 shows a schematic depiction of an embodiment of content access information for two example users of a digital content item.

FIG. 4 shows a schematic depiction of a grouping of users based upon content access patterns for a plurality of digital content items.

FIG. 5 shows a block diagram illustrating an example embodiment of a computing device.

### DETAILED DESCRIPTION

As mentioned above, different users may consume digital content items in different ways. For example, users may play various areas in a video game world in different orders, may choose to play as certain characters, etc. Such behaviors may be evident in the way that the users access various portions of a digital content item.

As a user downloads and progresses through a digital content item, the computing device with which the user is experiencing the digital content item may access portions of the content that correspond, for example, to features of the particular portion of the digital content item currently being consumed by the user. It will be understood that a “content portion” may or may not correspond to a discrete feature, file, object, etc. of the digital content item, and that the term “content portion” denotes any portion of data of the digital content item.

As a downloadable digital content item may be accessed by multiple users, tracking temporal information regarding how each user accesses the content portions of the selected digital content item may allow groups of users with similar content access patterns to be identified. This may allow content to be recommended based upon such groupings of users.

It will be appreciated that such content access patterns may be tracked without reference to what the content portions represent, for example, by tracking accessed content portions in the form of identifications of specific portions of memory, such as memory locations, disk segments, memory offsets from a beginning of a digital content item, etc. at which the portions are stored. This may allow users to be grouped without having to define any particular grouping scenario up front (e.g. user play style, avatar/character preference, genre preference, etc.), and without having to understand the underlying basis for the similarities in content access patterns.

In other embodiments, descriptive metadata may exist that describes one or more content portions. In such embodiments, users may additionally be grouped by the comparison of such metadata. This may help to provide an understanding of the nature of the similarities underlying each grouping, and may offer additional information for determining an order in which content portions of other content items are provided to users.

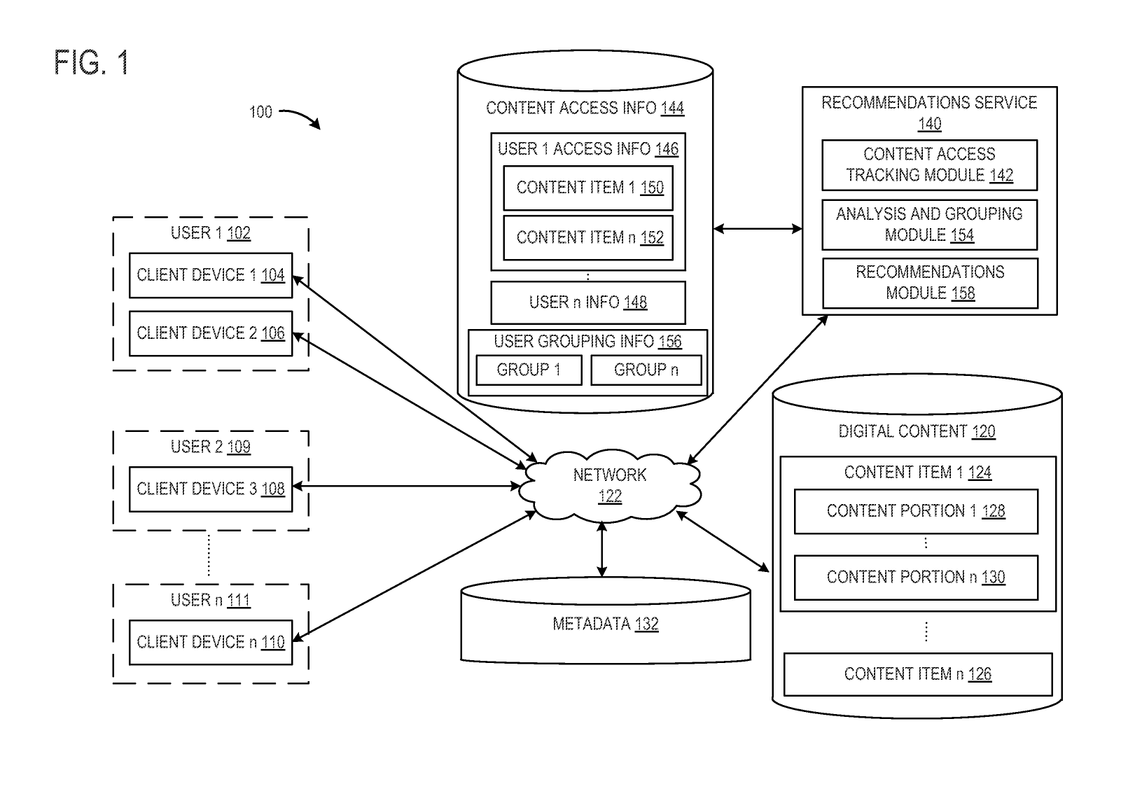

Prior to discussing these embodiments in more detail, an example embodiment of a use environment 100 is described with reference to FIG. 1. Use environment 100 comprises a plurality of client devices each configured to present digital content, wherein each client device is associated with a corresponding user. In some instances, more than one client device may be associated with a user. For example, a user may have a video game console, a mobile device, a computer (laptop, desktop, tablet), a wearable device (e.g. head-mounted display), etc., and may consume digital content on each of these devices. This is shown in FIG. 1 as a first user 102 having a first associated client device 104 (e.g. video game console) and a second associated client device 106 (e.g. mobile device, wearable device, portable device, computer, etc.). FIG. 1 also shows two other client devices associated with other users as client device 3 108 associated with user 2 109, and client device n 110 associated with user n 111 to illustrate the multi-user nature of use environment 100. While described in the context of a client-server environment, it will be understood that other embodiments may utilize any other suitable architecture, including peer-to-peer arrangements.

Each client device is in communication with one or more digital content stores 120 (e.g. locations from which digital content may be downloaded) via a network 122 (e.g. computer network, cellular phone network, and/or any other suitable type of network). Each client device also may be in communication with one or more other client device in a peer-to-peer arrangement for receiving digital content from peer devices. Digital content store 120 is depicted as storing a plurality of digital content items, illustrated as digital content item 1 124 and digital content item n 126.

Each digital content item comprises a plurality of content portions, examples of which are shown as content portion 1 128 and content portion n 130 for digital content item 1 124. Digital content items 124, 126 may represent any suitable type of digital content, including but not limited to interactive content such as video games, interactive video, and social media. Other examples include, but are not limited to, movies, television shows and other videos, music, photographs, websites, etc. Likewise, content portions 128, 130 may take any suitable form. For example, content portions 128, 130 may take the form of specific portions of memory, or, by extension, specific files, etc.

As mentioned above, in some embodiments one or more content portions may have associated descriptive metadata that describes an identity, characteristic, and/or other property of the content portion. For example, in the case of a video game, metadata 132 may comprise information regarding an identity of one or more virtual objects (e.g. character/object identification, location/setting, etc.) represented (partially or fully) by a content portion. Metadata 132 also may comprise information regarding the digital content item as a whole (e.g. genre), and/or any other suitable information. Such metadata is illustrated in FIG. 1 as being stored in a metadata store 132 that is located remotely from the digital content store 120. However, it will be understood that metadata 132 may be stored in any suitable location, including with the corresponding content item in some embodiments.

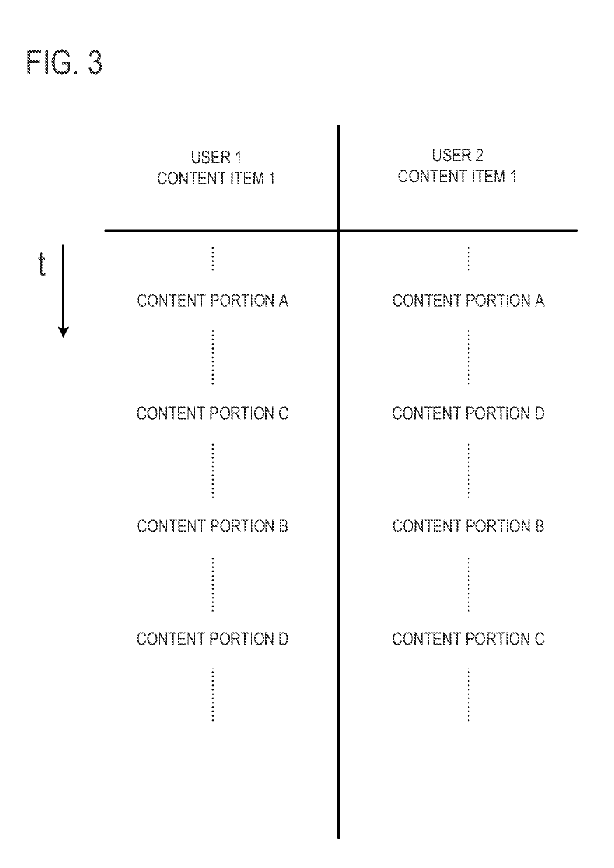

As mentioned above, content access information regarding how users access content items may be used to provide recommendations of other content items for the users. Thus, a recommendations service 140 may receive and track temporal information regarding how users accessed content portions of digital content items, and may provide recommendations of digital content to client devices based upon similarities in the content access patterns of users. The depicted recommendations service 120 comprises a content access tracking module 142 configured to track content access information for users of recommendations service 120, and to store this information in a content access information store 144. Content access information store 144 may store content access information for a plurality of users, illustrated as user 1 information 146 and user n information 148, and likewise may store content access information for each digital content item accessed by each user, illustrated for user 1 146 as access information for content item 1 150 and access information for content item n 152. The content access information stored for each digital content item accessed by each user may comprise any suitable information, including but not limited to an order in which content portions of each digital content item were accessed by that user, and/or other such temporal information, as described below with reference to FIG. 3.

Content access information may be provided to the recommendations service by client devices as users download and consume digital content on the client devices (or at a later time after downloading), by a digital content provision service that provides digital content to clients, and/or from any other suitable source. Further, in some embodiments, the recommendations service may be included with a digital provision service, and thus may monitor content access patterns as content is downloaded from the digital provision service.

Recommendations service 140 further comprises an analysis and grouping module 154 configured to analyze content access information, and to identify groups of users based, for example, upon similarities in content access patterns. Analysis and grouping module 154 may be configured to compare any suitable content access information to identify such groups of users. For example, analysis and grouping module 154 may compare content access information for a single interactive content item, within a family of titles, within a selected genre, within multiple titles of different genres, and/or for any other suitable content. Further, as mentioned above, where descriptive metadata is available that describe content portions, such metadata also may be compared to help identify groups of similar users. It will be understood that information regarding the identities of users in each group of similar users may be stored in some embodiments. This is shown in FIG. 1 as user grouping info 156 comprising information on n groups of similar users.

Recommendations service 140 further may include a recommendations module 158 configured to identify digital content recommendations to send to users based upon digital content consumed by other users identified as similar. Recommendations module 158 may identify recommendations based upon any suitable factor or factors. For example, the recommendations may be selected based upon content consumption information stored for the other users in a group of similar users. Any suitable content consumption information may be used to generate recommendations. For example, in some embodiments, such information may include digital content consumed previously by the other users in the group, digital content commented upon by other users in the group, digital content liked by other users in the same group, digital content consumed/commented/liked by social network contacts of the other users in the group, etc. Further, the recommendations may be made based upon similarities of the recommended digital content items to digital content consumed/etc. previously by the other users in the group, such as similar title, genre, artist, actor, character, etc. The recommended content may be of a same type or different type as the interactive content used for correlating content access information.

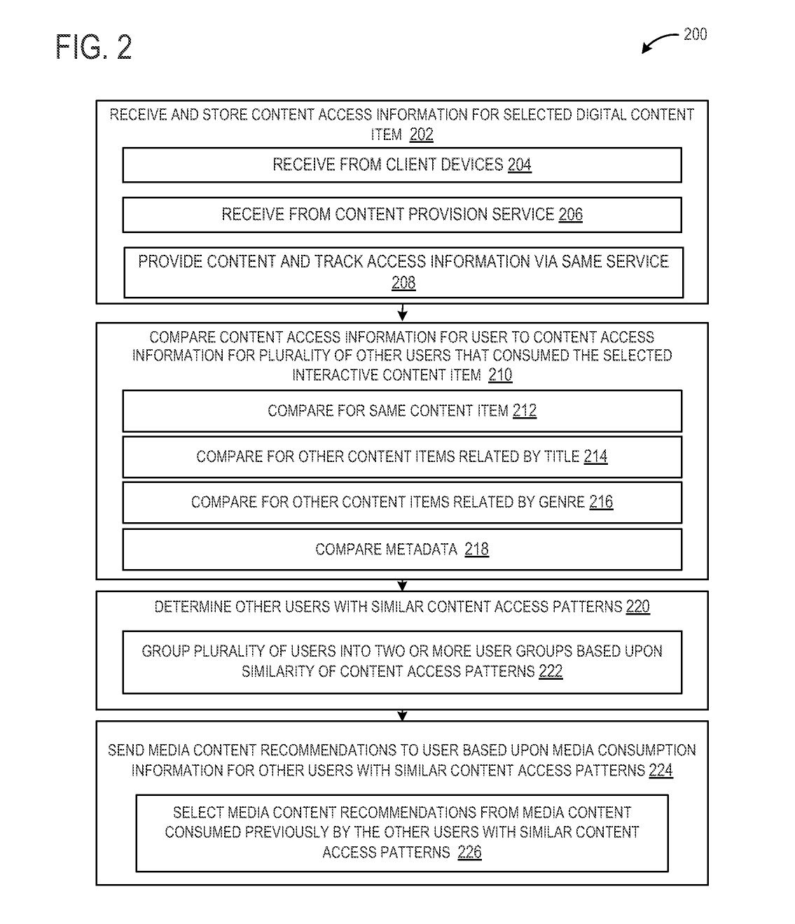

FIG. 2 shows a flow diagram depicting an embodiment of a method 200 for providing digital content recommendations to a user based upon comparing content access information of a plurality of users of a digital content service. Method 200 may be implemented via any suitable computing system, example embodiments of which are described below.

Method 200 comprises, at 202, receiving and storing content access information for a selected digital content item. The content access information may be received from a client device used to download and consume digital content, as indicated at 204, from a content provision service that provides digital content to users, as indicated at 206, and/or from any other suitable source. As mentioned above, in some embodiments, a same service may provide content and track content access information, as indicated at 208.

The content access information may comprise any suitable information, including but not limited to an order in which portions of the selected digital content item were accessed by users. As another example, the content access information may comprise well as temporal information regarding a relative elapsed time at which each asset was accessed. As mentioned above, the content portions take any suitable form, including but not limited to specific memory locations at which the accessed portions of the content item are stored. The selected digital content item may be a video game 208, and/or any other suitable type of digital content.

FIG. 3 shows a schematic depiction of a simplified example set of content access information for each of two users that accessed digital content item 1. In the depicted embodiment, digital content item 1 comprises an arbitrary set of content portions including portions a, b, c and d. A relative order in which these content portions were accessed by each user is illustrated on a vertical time axis, and shows that these four content portions were requested and sent in different orders for the two users. It will be understood that such content access information may be collected for any number of users that access a digital content item.

Continuing, method 200 next comprises, at 210, comparing the content access information stored for the user to content access information stored for a plurality of other users that consumed the selected interactive content item to identify other users with similar content access patterns. As mentioned above, content access information may be compared for the same content item, as indicated by 212, and/or for other content items that are related by title 214, by genre 216, and/or by any other suitable relationship. Additionally, as indicated at 218, in some embodiments, descriptive metadata associated with the content portions may be compared to help identify similar users.

Based upon comparing the content access information for the users, method 200 next comprises, at 220, determining other users with similar content access patterns. Such a determination may be made in any suitable manner. For example, as indicated at 222, such a determination may comprise grouping a plurality of users into two or more groups via a computing system-implemented collaborative filtering algorithm(s) that correlates the content access patterns of the users to identify users with similar access patterns.

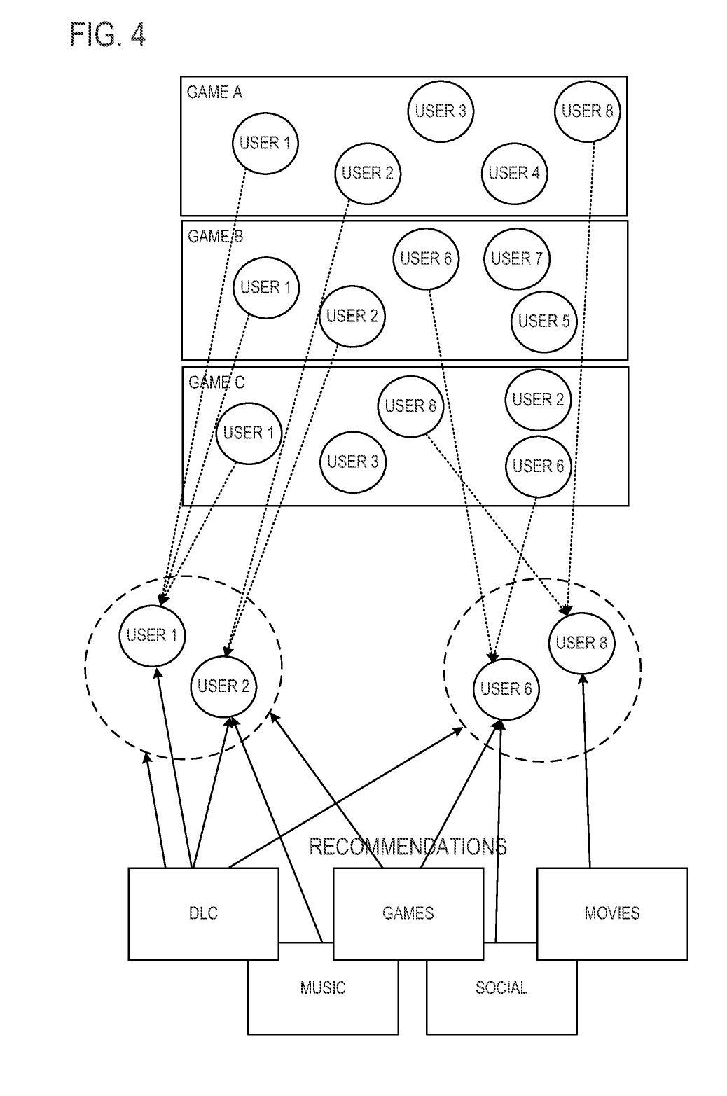

Method 200 further comprises, at 224, sending digital content recommendations to the user based upon content consumption information for other users with similar content access patterns. Any suitable recommendations may be provided, including but not limited to recommendations of interactive digital content (e.g. video games, interactive video, social media, etc.), as well as non-interactive content (e.g. movies, television shows, music, etc. FIG. 4 shows a schematic example of a grouping of users based upon content access patterns for a group of different interactive content items, illustrated as video games A, B and C. Video games A, B and C may be related by title, genre, other characteristic or quality, or unrelated. It will be understood that any other suitable interactive content other than video games also may be used.

As shown, it may be determined via the above-described processes that user 1 and user 2 accessed game A and/or game B in similar manners. Based upon this determination, user 1 and user 2 may be grouped together. Likewise, it may be determined that user 6 and user 8 accessed game B and/or game C in a similar manner. Thus, user 6 and user 8 may be similarly grouped together. Content recommendations then may be provided to each user based upon other users in the same group. This may help to identify content enjoyed by other users with similar interests and/or content consumption styles. Further, in some embodiments, providing recommendations of content may comprise pre-fetching recommended content so that the user receiving the recommendation may begin to play the recommended content with less time lag.

The recommendations may be made based upon any suitable factor or factors. For example, the recommendations may be selected based upon content consumption information stored for the other users in the group. Such information may include digital content consumed previously by the other users in the group, as indicated at 226. Such information also may include additional information, such as digital content commented upon by other users in the group, digital content liked by other users in the same group, digital content consumed/commented/liked by social network contacts of the other users in the group, etc. Further, the recommendations may be made based upon similarities of the recommended digital content items to digital content consumed/etc. previously by the other users in the group, such as similar title, genre, artist, actor, character, etc. Such information may be stored and accessed locally to a recommendations service, and/or stored and accessed remotely.

The recommended content may be of a same type or different type as the interactive content used for correlating content access information. In the embodiment of FIG. 4, recommended content is illustrated as including downloadable content (DLC), games, movies, music, and social media, but any other suitable types of digital content may be recommended.

The recommendations may be sent to any suitable device. For example, the recommendations may be sent to the device used for the gathering of content access information, and/or may be sent to another device associated with the user. As one non-limiting example, the content access information for a user may be collected as the user plays a video game via a video game console, and recommendations may be sent to a user's mobile device. Further, as indicated via the arrows in FIG. 4, recommendations may be made to individual group members, or to the group as a whole, depending upon the context in which the recommendations are being provided.

In some embodiments, the methods and processes described above may be tied to a computing system of one or more computing devices. In particular, such methods and processes may be implemented as a computer-application program or service, an application-programming interface (API), a library, and/or other computer-program product.

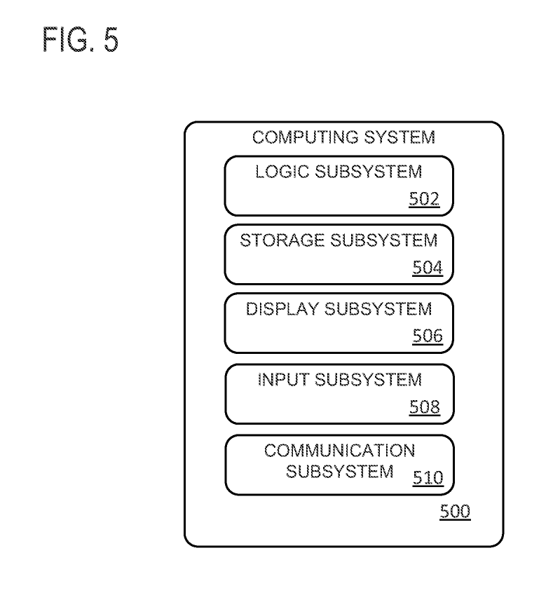

FIG. 5 schematically shows a non-limiting embodiment of a computing system 500 that can enact one or more of the methods and processes described above. Computing system 500 is shown in simplified form. It will be understood that virtually any computer architecture may be used without departing from the scope of this disclosure. In different embodiments, computing system 500 may take the form of a mainframe computer, server computer, desktop computer, laptop computer, tablet computer, home-entertainment computer, network computing device, gaming device, mobile computing device, mobile communication device (e.g., smart phone), etc.

Computing system 500 includes a logic subsystem 502 and a storage subsystem 504. Computing system 500 may optionally include a display subsystem 506, input subsystem 508, communication subsystem 510, and/or other components not shown in FIG. 5.

Logic subsystem 502 includes one or more physical devices configured to execute instructions. For example, logic subsystem 502 may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

Logic subsystem 502 may include one or more processors configured to execute software instructions. Additionally or alternatively, logic subsystem 502 may include one or more hardware or firmware logic machines configured to execute hardware or firmware instructions. The processors of logic subsystem 502 may be single-core or multi-core, and the programs executed thereon may be configured for sequential, parallel or distributed processing. Logic subsystem 502 may optionally include individual components that are distributed among two or more devices, which can be remotely located and/or configured for coordinated processing. Aspects of logic subsystem 502 may be virtualized and executed by remotely accessible, networked computing devices configured in a cloud-computing configuration.

Storage subsystem 504 includes one or more physical, non-transitory, devices configured to hold data and/or instructions executable by the logic subsystem to implement the methods and processes described herein. When such methods and processes are implemented, the state of storage subsystem 504 may be transformed—e.g., to hold different data.

Storage subsystem 504 may include removable media and/or built-in devices. Storage subsystem 504 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard-disk drive, floppy-disk drive, tape drive, MRAM, etc.), among others. Storage subsystem 506 may include volatile, nonvolatile, dynamic, static, read/write, read-only, random-access, sequential-access, location-addressable, file-addressable, and/or content-addressable devices.

It will be appreciated that storage subsystem 504 includes one or more physical, non-transitory devices. However, in some embodiments, aspects of the instructions described herein may be propagated in a transitory fashion by a pure signal (e.g., an electromagnetic signal, an optical signal, etc.) that is not held by a physical device for a finite duration. Furthermore, data and/or other forms of information pertaining to the present disclosure may be propagated by a pure signal.

In some embodiments, aspects of logic subsystem 502 and of storage subsystem 504 may be integrated together into one or more hardware-logic components through which the functionally described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

The terms “module” and “program” may be used to describe an aspect of computing system 500 implemented to perform a particular function. In some cases, a module or program may be instantiated via logic subsystem 502 executing instructions held by storage subsystem 504. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms “module” and “program” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 506 may be used to present a visual representation of data held by storage subsystem 506. This visual representation may take the form of a graphical user interface (GUI). As the herein described methods and processes change the data held by the storage subsystem, and thus transform the state of the storage subsystem, the state of display subsystem 506 may likewise be transformed to visually represent changes in the underlying data. Display subsystem 506 may include one or more display devices utilizing virtually any type of technology. Such display devices may be combined with logic subsystem 502 and/or storage subsystem 504 in a shared enclosure, or such display devices may be peripheral display devices.

When included, input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, steroscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, communication subsystem 510 may be configured for communication via a wireless telephone network, or a wired or wireless local- or wide-area network. In some embodiments, communication subsystem 510 may allow computing system 500 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method of providing digital content recommendations to a user, the method comprising:
receiving from a remote computing device content access information regarding an order in which content portions of a selected digital content item were accessed by the user;
storing the content access information for the user;
comparing the content access information for the user to content access information for a plurality of other users that consumed the selected digital content item to determine one or more other users with similar content access patterns; and
sending one or more digital content recommendations for presentation to the user based upon content consumption information for the one or more other users with similar content access patterns.

2. The method of claim 1, wherein the content access information represents a content portion as a memory location at which the content portion is accessible.

3. The method of claim 2, wherein the content access information represents a content portion as a specified file.

4. The method of claim 1, further comprising providing the selected digital content item to the remote computing device

5. The method of claim 1, wherein the selected digital content item comprises a video game.

6. The method of claim 5, wherein the digital content recommendations include one or more recommendations for content other than video games.

7. The method of claim 1, wherein comparing the content access information for the user to content access information for a plurality of other users comprises comparing content access information for other content items than the selected digital content item.

8. The method of claim 7, wherein one or more of the other content items are related to the selected digital content item by title.

9. The method of claim 7, wherein one or more of the other content items are related to the selected digital content item by genre.

10. On a computing device, a method of providing digital content recommendations to a user, the method comprising:
for each user of a plurality of users of a selected digital content item comprising a plurality of content portions, storing content access information regarding an order in which content portions of the interactive content item are accessed by the user;
comparing the content access information for the plurality of users;
grouping the plurality of users into two or more groups based upon a similarity of content access information for each user in a same group; and
sending one or more digital content recommendations to a selected user based upon content consumption information for other users in the same group as the selected user.

11. The method of claim 10, wherein each content portion is represented in the content access information as a specified portion of memory.

12. The method of claim 10, wherein each asset comprises a specified file.

13. The method of claim 10, further comprising sending the selected digital content items to one or more users.

14. The method of claim 10, wherein the interactive content item comprises a video game.

15. The method of claim 14, wherein the digital content recommendations include one or more recommendations for content other than video games.

16. The method of claim 10, wherein comparing the content access information for each user to the content access information of other users comprises comparing content access information for other content items than the selected digital content item.

17. The method of claim 16, wherein one or more of the other content items are in one or more of a same title family and a same genre as the selected digital content item.

18. A computing system, comprising:
a logic subsystem; and
a data-holding subsystem comprising instructions stored thereon that are executable by the logic subsystem to:
receive from the remote computing device content access information regarding an order in which content portions of the selected video game were accessed;
store the content access information for the user;
compare the content access information for the user to content access information for other users that consumed the selected digital content item to determine one or more other users with similar content access patterns for the selected digital content item;
select one or more digital content recommendations for the user from past digital content consumed by the one or more other users with similar content access patterns for the selected digital content item; and
send the one or more digital content recommendations to the user based upon content consumption information for the one or more other users with the similar content access patterns.

19. The computing device of claim 18, wherein the code is executable to compare the content access information for each user to the content access information of other users by comparing content access information for other content items than the selected digital content item.

20. The computing device of claim 19, wherein one or more content items of the other content items are in one or more of a same title family and a same genre as the selected digital content item.
